(19) United States
(12) Patent Application Publication
(10) Pub. No.: US 2008/0281838 A1
(43) Pub. Date: Nov. 13, 2008

(54) METHOD OF DETERMINING DEPENDENCIES BETWEEN ITEMS IN A GRAPH IN AN EXTENSIBLE SYSTEM

(75) Inventor: Jack A. Nichols, Kirkland, WA (US)

Correspondence Address: DAVIS WRIGHT TREMAINE, LLP/Seattle, 1201 Third Avenue, Suite 2200, SEATTLE, WA, 98101-3045, US

(73) Assignees: RESOLUTE SOLUTIONS CORPORATION, Bellevue, WA (US); Kivati Software, LLC, Bellevue, WA (US)

(21) Appl. No.: 12/115,483

(22) Filed: May 5, 2008

Related U.S. Application Data
(60) Provisional application No. 60/915,846, filed on May 3, 2007.

(51) Int. Cl. G06F 17/30

(52) U.S. Cl. 707/100; 707/E17.044

(57) ABSTRACT

A dependency determination system and method determines dependencies among extensions of an extensible system based upon a directed graph thereof. Dependencies between extensions in an extensible system are expressed as a directed graph. Given the dependency graph for an extensible system or its data, the dependency system can traverse the graph and operate on or find the correct order for the extensions in the extensible system or for the data created by extensions in the extensible system. Constructing the dependency graph is done with knowledge of the extensions in question and is constructed by input from the extensions. Consequently, input from extensions is first gathered to construct the graph.

### CROSS REFERENCE TO RELATED APPLICATION(S)

This application claims priority benefit of provisional application Ser. No. 60/915,843 filed May 3, 2007, the content of which is incorporated in its entirety.

This application is related to copending application by Jack A. Nichols, entitled “A Method For Determining And Storing The State Of A Computer System”, filed on May 5, 2008, herewith U.S. patent application Ser. No. 12/115,476, which application is hereby incorporated by reference in its entirety, including any appendices and references thereto.

This application is related to copending application by Jack A. Nichols, entitled “A Method For Differentiating States Of N Machines”, filed on May 5, 2008, herewith U.S. patent application Ser. No. 12/115,479, which application is hereby incorporated by reference in its entirety, including any appendices and references thereto.

This application is related to copending application by Jack A. Nichols, entitled “A Method For Performing Tasks Based On Differences In Machine State”, filed on May 5, 2008, herewith U.S. patent application Ser. No. 12/115,487, which application is hereby incorporated by reference in its entirety, including any appendices and references thereto.

### BACKGROUND OF THE INVENTION

1. Field of the Invention

The present invention is directed generally to extensible software systems.

2. Description of the Related Art

Older software systems were typically built in such a way that they were closed off to the outside world and could not be extended. These type of systems are today known as monolithic systems. Although these systems were in some respects easier to build than modern systems, they suffered from a lack of customizability that limited their usefulness. A user that needed to change the behavior of the software had only a few realistic options: the user could look for an option in the program to control the behavior that he or she was looking for, or the user could ask the vendor for an update with the required functionality.

Modern software systems are typically built such that they can be extended by their users. Depending on the skill of the user and what the software system offers, the user can extend the software system using a combination of programming languages, macros, and other tools. These tools allow the user to “plug-in” extensions to the system and add or change behavior that is not otherwise possible. These types of systems are commonly known as plugin-based systems, provider-based systems, extensible systems, and other terms.

The complexity of an extensible system is greater than one that is not extensible. For example, the writers of the extensible system should add application programming interfaces (APIs) to their system in order to allow users to extend it. As well, the writers of the extensible system should provide some sort of mechanism for users to get their extensions loaded and used by the system. The writers of an extensible system should also extensively test their system to ensure that plug-ins work properly.

The complexity of an extensible system is greater for its users than a system that is not extensible. A user wishing to extend a system should become familiar with it, learn about its application programming interfaces, and learn about the mechanism used to load an extension into the system. The user should then write his or her extension and test it in the extensible software system.

Most extensible systems will have more than one extension in use at a given time. These extensions may or may not be authored by the same user, and it is usually expected that in most cases these extensions will not be authored by the same user. If the extensible system permits it and more than one extension is loaded at a given time, extensions may cause conflicts with one another. The extensible system and its extensions generally should have a mechanism to ensure that these conflicts do not occur.

Extensions written by users may periodically need to communicate with one another to achieve the desired functionality. In order to facilitate this, the extensible system should provide some sort of mechanism for one extension to communicate with or use another extension. An extension wishing to use or communicate with another extension should generally have some knowledge of the other extension and how it operates in order to use it, or even to request it from the extensible system.

An extension wishing to use or communicate with another extension may find that the extension it seeks is not loaded or installed into the extensible system. Such an occurrence is quite common and the extension and extensible system should be able to handle such a situation.

The author of an extension wishing to use or communicate with another extension may not want or may not be able to maintain a “hard reference” to the target extension by explicitly specifying it. It is more desirable to maintain a “soft reference” or specify an extension by its characteristics rather than specifying it explicitly. For example, the author of an extension may wish to specify “an extension that performs function A” rather than “the extension named XYZ”.

In general and in light of the above problems, authoring an extension that uses another extension is significantly more difficult than authoring an extension that does not. In some cases, authoring such an extension may be impossible, depending on the nature of the extensible system. In a system that permits extensions to use or communicate with other extensions, usually a dependency relationship exists between the extensions. For example, extension A may depend on extension B because extension A uses extension B. In such a system, the extensible system should provide a mechanism for managing dependencies such that it is easy for the extension author to specify them.

There can be multiple types of dependencies, depending on the extensible system and its providers. For example, a system may allow a “uses” dependency, in which extension A uses extension B. Alternatively, a system may allow a “before” dependency, in which extension A must perform some task before extension B can execute. Dependency relationships can exist either between extensions or between data expressed or specified by the extensions. For example, a system may use extensions to create data that has dependencies on other data, and by virtue of being dependant on other data, is dependent on other extensions.

### BRIEF DESCRIPTION OF THE SEVERAL VIEWS OF THE DRAWING(S)

FIG. 1 is a schematic block diagram of a computer and associated equipment that is used with implementations of the system.

FIG. 2 is a schematic of a simple file system structure illustrating the dependency relationships between files and directories

FIG. 3 is a schematic representation of a simple web site hierarchy illustrating the dependency relationships between components of the web site

FIG. 4 is a dependency graph for the example presented in FIG. 2

### DETAILED DESCRIPTION OF THE INVENTION

A dependency determination system and method for extensible systems is disused herein. The dependency system determines dependencies among extensions of an extensible system based upon a directed graph thereof. Dependencies between extensions in an extensible system are expressed as a directed graph. Given the dependency graph for an extensible system or its data, the dependency system can traverse the graph and operate on or find the correct order for the extensions in the extensible system or for the data created by extensions in the extensible system.

Constructing the dependency graph is done with knowledge of the extensions in question and is constructed by input from the extensions. Consequently, input from extensions is first gathered to construct the graph.

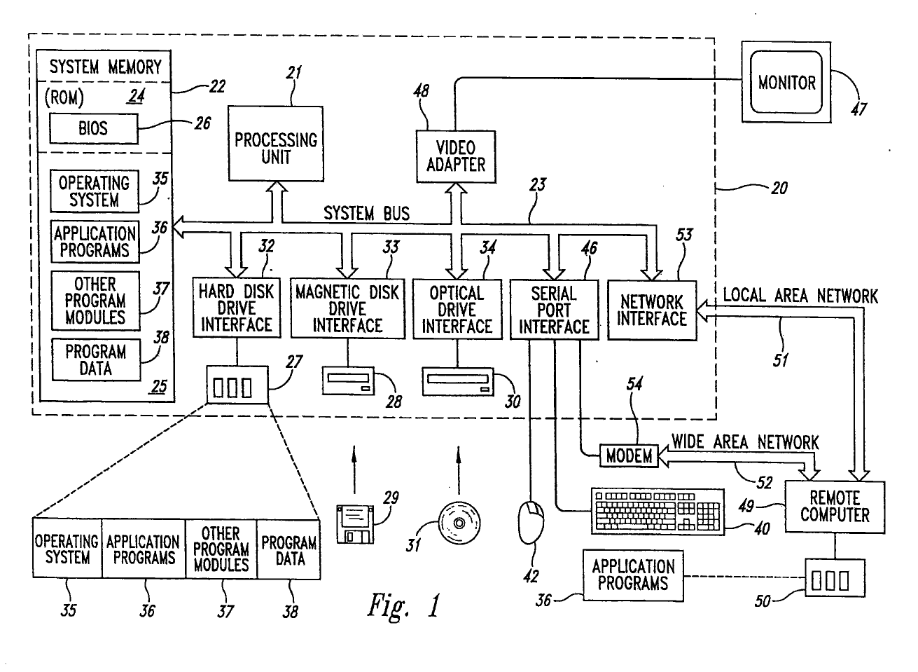

FIG. 1 is a diagram of the hardware and operating environment in conjunction with which implementations may be practiced. The description of FIG. 1 is intended to provide a brief, general description of suitable computer hardware and a suitable computing environment in which implementations may be practiced. Although not required, implementations are described in the general context of computer-executable instructions, such as program modules, being executed by a computer, such as a personal computer. Generally, program modules include routines, programs, objects, components, data structures, etc., that perform particular tasks or implement particular abstract data types.

Moreover, those skilled in the art will appreciate that implementations may be practiced with other computer system configurations, including hand-held devices, multiprocessor systems, microprocessor-based or programmable consumer electronics, network PCs, minicomputers, mainframe computers, and the like. Implementations may also be practiced in distributed computing environments where tasks are performed by remote processing devices that are linked through a communications network. In a distributed computing environment, program modules may be located in both local and remote memory storage devices.

The exemplary hardware and operating environment of FIG. 1 includes a general purpose computing device in the form of a computer 20, including a processing unit 21, a system memory 22, and a system bus 23 that operatively couples various system components, including the system memory 22, to the processing unit 21. There may be only one or there may be more than one processing unit 21, such that the processor of computer 20 comprises a single central-processing unit (CPU), or a plurality of processing units, commonly referred to as a parallel processing environment. The computer 20 may be a conventional computer, a distributed computer, or any other type of computer.

The system bus 23 may be any of several types of bus structures including a memory bus or memory controller, a peripheral bus, and a local bus using any of a variety of bus architectures. The system memory may also be referred to as simply the memory, and includes read only memory (ROM) 24 and random access memory (RAM) 25. A basic input/output system (BIOS) 26, containing the basic routines that help to transfer information between elements within the computer 20, such as during start-up, is stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM or other optical media.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated computer-readable media provide nonvolatile storage of computer-readable instructions, data structures, program modules and other data for the computer 20. It should be appreciated by those skilled in the art that any type of computer-readable media which can store data that is accessible by a computer, such as magnetic cassettes, flash memory cards, digital video disks, Bernoulli cartridges, random access memories (RAMs), read only memories (ROMs), and the like, may be used in the exemplary operating environment.

A number of program modules may be stored on the hard disk, magnetic disk 29, optical disk 31, ROM 24, or RAM 25, including an operating system 35, one or more application programs 36, other program modules 37, and program data 38. A user may enter commands and information into the personal computer 20 through input devices such as a keyboard 40 and pointing device 42. Other input devices (not shown) may include a microphone, joystick, game pad, satellite dish, scanner, or the like. These and other input devices are often connected to the processing unit 21 through a serial port interface 46 that is coupled to the system bus, but may be connected by other interfaces, such as a parallel port, game port, or a universal serial bus (USB). A monitor 47 or other type of display device is also connected to the system bus 23 via an interface, such as a video adapter 48. In addition to the monitor, computers typically include other peripheral output devices (not shown), such as speakers and printers.

The computer 20 may operate in a networked environment using logical connections to one or more remote computers, such as remote computer 49. These logical connections are achieved by a communication device coupled to or a part of the computer 20, the local computer; implementations are not limited to a particular type of communications device. The remote computer 49 may be another computer, a server, a router, a network PC, a client, a peer device or other common network node, and typically includes many or all of the elements described above relative to the computer 20, although only a memory storage device 50 has been illustrated in FIG. 1. The logical connections depicted in FIG. 1 include a local-area network (LAN) 51 and a wide-area network (WAN) 52. Such networking environments are commonplace in offices, enterprise-wide computer networks, intranets and the Internet.

When used in a LAN-networking environment, the computer 20 is connected to the local network 51 through a network interface or adapter 53, which is one type of communications device. When used in a WAN-networking environment, the computer 20 typically includes a modem 54, a type of communications device, or any other type of communications device for establishing communications over the wide area network 52, such as the Internet. The modem 54, which may be internal or external, is connected to the system bus 23 via the serial port interface 46. In a networked environment, program modules depicted relative to the personal computer 20, or portions thereof, may be stored in the remote memory storage device. It is appreciated that the network connections shown are exemplary and other means of and communications devices for establishing a communications link between the computers may be used.

The hardware and operating environment in conjunction with implementations that may be practiced has been described. The computer in conjunction with implementation that may be practiced may be a conventional computer, a distributed computer, or any other type of computer. Such a computer typically includes one or more processing units as its processor, and a computer-readable medium such as a memory. The computer may also include a communications device such as a network adapter or a modem, so that it is able to communicatively couple to other computers.

Extensions in an extensible system with dependencies may not be able to provide complete dependency information without knowledge of other extensions. For example, if extension A depends on extension B, it must know enough about extension B to explicitly specify extension B in the dependency. This adds further complexity in that such a system may require extensions to specify dependencies in a specific order. In some cases, this may not even be possible. The desire to specify soft references from extension to extension and the requirement for the dependency graph to specify a specific extension can be in conflict with one another.

In implementations, the dependency system is built as an extensible system that stores the state of a machine using a series of extensions. The state of the machine is stored in a simple file on disk as described in co-pending patent application entitled, “A Method of Determining and Storing the State of a Computer System.” and can be later opened and analyzed by other software to perform interesting operations. The dependency system is built in such a way that it delegates control of the state analysis to the extensions, and each extension is responsible for analyzing the state of one or more specific types of item and storing the results of this analysis in the state file. Both first and third parties are able to add extensions as needed to support new functionality.

In this example, the dependency system is loaded with two extensions. One extension analyzes and stores information about directories on a disk. Another extension analyzes and stores information about files. The file system is typical of most modern file systems in that a directory can contain zero or more files, as well as contain zero or more directories.

The dependency system uses the extensions in such a way that the dependency system asks each extension to store state information about a specific type of data. Each extension may store many instances of the data, each instance representing a different item in the machine's state. Each of these data items may specify dependencies on other data. With the data created by the example extensions above, a dependency means that an item is to be created in the file system before another item. For example, a file “resume.doc” must be created in the file system after the folder it is stored in is created.

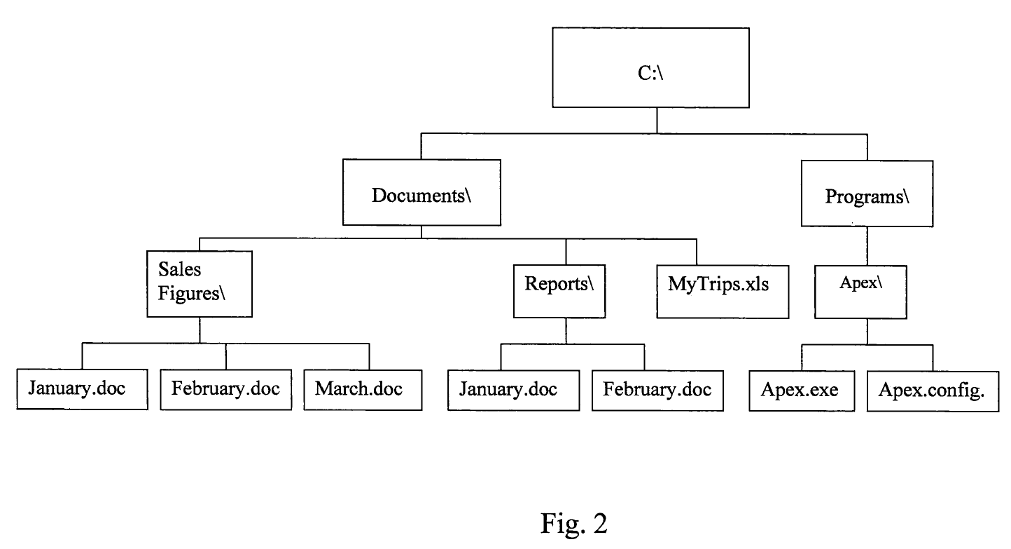

The notion of an item being created before an item is specific to the extensions and extension data in this example; indeed, other extensions may specify data with dependencies that have a different semantic meaning. For example, consider the directory structure shown in FIG. 2. In the diagram, items with a trailing slash (\) are considered to be directories.

Looking at the diagram and understanding basic file system concepts, it is apparent that in order for “My Trips.xls” to be created in the file system, the directory “Documents” must be created first. To express this relationship, a dependency is created. We say that the data for “My Trips.xls” (handled by the file extension) is dependent on the data for “Documents” (handled by the directory extension). However, the dependency system needs a way to specify what type of object “Documents” is.

More specifically, it is possible that could have a file also named “Documents”, and so the dependency system needs a way to distinguish between a file “Documents” and a directory “Documents”. Additionally, it is not desirable for the file extension to create data that names an explicit dependency on data created by the directory extension. To do so would necessitate that the directory extension be distributed with the file extension, as well as have knowledge about it, and this may not be possible for a variety of reasons (legal, logistical, practical, etc.)

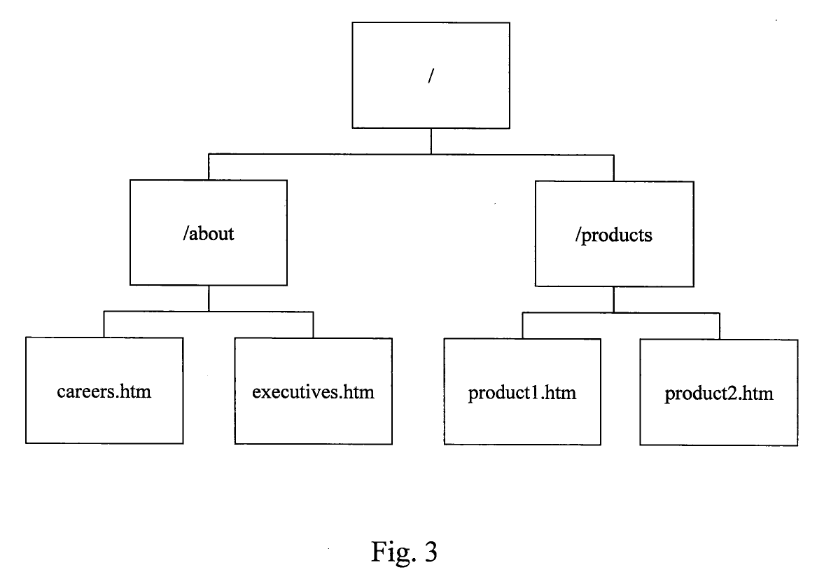

Looking at a different example fleshes out these issues further. Consider a web site with the structure shown in FIG. 3.

Using the above concepts, the dependency system can state that “careers.htm” has a dependency on “/about”. Conceptually, the dependency system would call “careers.htm” a page and “/about” a folder, but this may not accurately reflect what either of these items actually is. For instance, “careers.htm” may be a virtualized file, or a file created on-the-fly by the web server software based on data in a database. Furthermore, “/about” looks like a directory, but it could be any number of things, such as a virtualized directory, a directory on another computer, a real directory, etc. A more appropriate way to express the dependency between “careers.htm” and “/about” is “careers.htm depends on a URL of/about”. The concept of “URL” may mean something different in each context, but the dependency can be safely expressed in this manner.

The dependency system describes a method and accompanying data structures that deterministically calculate dependencies between vertices in a graph that specify dependencies with a soft reference. In reference to the above examples, it provides a mechanism for extensions or data created by extensions in a software system to specify both items that they depend on and names that other items may know them by, in such a way that hard references to the other systems are not required. The order in which extensions specify soft dependencies is not important, and implementations may choose to allow extensions to specify soft dependencies in an arbitrary order.

In some implementations, the dependency system requires extensions to specify their soft reference dependencies in the form of evidence. Evidence is a numerical description of the functionality or characteristics of the extension. For instance, evidence may include “File A” or “Fax Machine”. Extensions specify evidence by specifying the type of evidence that they are using and a string that represents the functionality or item being declared as evidence. The evidence type and string are converted to a numerical representation using a hash method that a person with ordinary skill in the art of computer science can implement.

Two required properties of the numerical representation of evidence are that each numerical representation be both unique and predictable¹. The uniqueness property means that for any given numerical value N where N=F(A), with A representing a value and F representing a numerical transform, the set of values that generate numerical value N using transform F is exactly {A}. The predictability property means that for identical values A and B and numerical transform F, F(A)=F(B). ¹ Mathematically, a hash function that takes a variable-length input and produces a fixed-length output retains the possibility of producing collisions. However, the probably of such an occurrence is so low as it should be considered impossible for the purposes of this method.

Looking at a specific example, consider the following types of evidence as shown in Table 1:

TABLE 1

| Evidence Type | Description |
|---|---|
| URL Evidence | Represents a URL, such as that discussed |
| | in the above example |
| Path Evidence | Represents the concept of a path, such as |
| | a directory or network share |
| String Evidence | Represents a generic evidence object |

Now, consider the following instances of evidence as shown in Table 2. Each instance is shown with its numeric value.

TABLE 2

| Evidence Instance | Numeric Value |
|---|---|
| URL Evidence = “/about” | 0x65cf7428e1b5aaee317525ed1a02284f |
| Path Evidence = “/about” | 0x8c164884c2bc3361efd034f9d7941eee |
| String Evidence = “/about” | 0x4dc4725c4c5c42271db4a7dd0a5e7fb2 |

The numeric value in the above table is calculated by taking the MD5 hash of the evidence type string and the string contained within the evidence, although other implementations of the dependency system could use other hash methods. This value, combined with the evidence type, is guaranteed to be unique by the hash method, and therefore the dependency system has three instances of evidence with the same fundamental value, but of different types, and therefore with different numeric values. Because the hash value is predictable if one knows the input parameters (type and value), one will always generate the same numeric value for the same set of inputs.

In some implementations, the dependency system uses extensions to specify two types of evidence. First, extensions specify consumed evidence. Consumed evidence specifies the evidence that the extension is dependent upon. Second, extensions specify produced evidence. Produced evidence specifies the evidence that other extensions may use to refer to the extension declaring the produced evidence. Produced evidence may include a variety of properties describing the data and/or its functions and metadata. The dependency system can consider the evidence contained within an extension to be a mathematical set. The dependency system can represent consumed evidence of extension A as the set CA and produced evidence of extension A as the set PA. Both CA and PA are sets with a uniqueness property (no item can appear more than once) and may be empty.

Evidence may also be expressed by specifying the evidence as the name of the set and specifying the items that produce or consume that evidence as the contents of the set. For this purpose, the dependency system will use the notation C′_{X} to represent the set of items that consume evidence X, and P′_{X} to represent the set of items that produce evidence X.

Turning again to the example of “careers.htm” depending on “/about” and assuming that these objects specify the following types of evidence as shown in Table 3:

TABLE 3

| Careers.htm | | /about | |
|---|---|---|---|
| Produced | Consumed | Produced | Consumed |
| URL Evidence = | URL Evidence = | URL Evidence = | URL |
| “/about/ | “/about” | “/about” | Evidence = “/” |
| careers.htm” | | | |

The sets representing the above table are:

TABLE 4

| Set | Contents of Set |
|---|---|
| C_{CAREERS.HTM} | {URL =”/about”} |
| P_{CAREERS.HTM} | {URL=”/about/careers.htm”} |
| C_{/ABOUT} | {URL=”/”} |
| P_{/ABOUT} | {URL=”/about”} |
| C′_{URL=”/about/careers.htm”} | { } |
| C′_{URL=”/about”} | {“careers.htm”} |
| C′_{URL=”/”} | {“/about”} |
| P′_{URL=”/about/careers.htm”} | {“careers.htm”} |
| P′_{URL=”/about”} | {“/about”} |
| P′_{URL=”/”} | { } |

Here, although “careers.htm” and “/about” are handled by different extensions, they both specify common types of evidence. In this case, both are specifying URL Evidence for their produced and consumed evidence. Analyzing this further, the dependency system can see that “careers.htm” depends on “/about”. The dependency system knows this because “careers.htm” declares that it consumes URL Evidence of “/about”, and therefore, “careers.htm” depends on any item that declares URL evidence of “/about”, which in this example, happens to be the item “/about”. The dependency system can also see from this example that “/about” depends on an item that produces URL Evidence of “/”, and although it isn't shown in the table, the dependency system could easily scan the list of items to find such an item.

This conclusion is clearer when the dependency system examines the second table of the sets. Looking at C_{CAREERS.HTM}, to find out the name of the item(s) on which it depends, the dependency system simply looks at the set representing each item in C_{CAREERS.HTM}. In this case, C_{CAREERS.HTM} contains only one item, URL=“/about”, so the dependency system looks for the set P′URL=“/about”, and see that it contains “/about”, and so the dependency system can conclude that “careers.htm” has a dependency on “/about”.

Formally, to determine if a dependency exists between extension A and extension B, one simply finds the intersection of the sets C_{A} and P_{B}. If the intersection set is non-empty, then a dependency exists. The existence of a dependency can be expressed as A→B, implying that B depends on A. It is also interesting to consider the opposite question—on which items does item A depend? The dependency system can find this list of items with a few simple steps, represented by the following pseudocode:

```
Let Ret = a list of items on which A depends
For each Evidence X in C_{A}
    for each Item Y in P’_{X}
        Add item Y to Ret
Return Ret
```

The performance of this method is dependent on the implementation. In a good implementation, the lookups for items and evidence should be fast, preferably running in O(Ig N) time at the worst, and usually implemented by a data structure such as a B-Tree, AVL Tree, database, or similar. Typically, the implementation should dictate how evidence is to be expressed to the system, and this should be very heavily tied to the data structure that catalogs evidence. In one implementation, a series of B-Trees are used that provide both enumerations of the consumed and produced evidence as well as an index into the produced evidence for fast lookups. This is, of course, not the only implementation choice, and any of the above data structures (or others) could be used without changing the way the method functions.

For this mechanism to work better, extensions should be using common evidence types. For this reason, it is important that the extensible system provide a series of types of evidence that meet the needs of the extensions. These evidence types should be sufficiently abstract so as to represent concepts that should be used in the system, rather than specific implementations. As well, the system should provide a generic evidence type (shown in the table above as “String Evidence”) that extensions can use when no other is appropriate. Of course, in this situation, it is incumbent upon the extension to provide an evidence value that is both unique and predictable, and so this approach should be discouraged if at all possible.

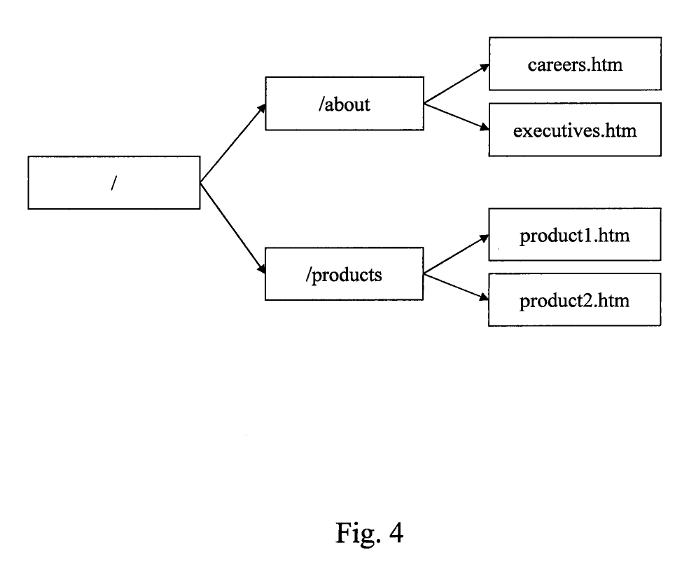

With a good understanding of how produced and consumed evidence can be matched, the dependency system can now construct a simple dependency graph by simply pairing produced and consumed evidence. The graph should be a directed graph, and the direction of the vertices (dependencies) between edges (nodes) should flow from the item producing the evidence to the item consuming the evidence. The image in FIG. 4 shows a simple dependency graph for the web site example presented above:

This example is implements the hierarchy shown above in a slightly different form. However, more complex digraphs are possible and are to be expected in real-world scenarios. It may be, for example, that “careers.htm” not only depends on “/about” but depends on “/products”, because products is a virtualized web folder that contains some data that will be displayed on the page “careers.htm”. In this case, a dependency arrow would be drawn between “/products” and “careers.htm”.

The manner of constructing the dependency graph above may vary with each implementation. The examples presented are for one implementation, and may vary with another. Another implementation may wish, for example, to reverse the order of the edges in the digraph, or disallow cross-links (such as from “/products” to “careers.htm”). The basic method of constructing the graph, however, remains the same.

To construct the dependency graph, implementations uses the following pseudocode. This pseudocode assumes that the list of items and their sets of evidence have already been constructed by the system. In the context of the above example system, the system has already asked all extensions to generate data, and that data contains the necessary produced and consumed evidence.

For the purposes of this pseudocode, the following data structure will be assumed:

### Item:

.P=produced evidence set, representing P_{ITEM}. Provided.
.C=consumed evidence set, representing C_{ITEM}. Provided.
.DependsOn=set of Item objects on which this item depends. Initially empty.

The pseudocode below assumes that V represents the list of Item objects that has been constructed as mentioned above. As well, a variable named P′ is declared that contains the index of produced evidence for given evidence item X. This variable is indexable (using square bracket notation such as P′[X]), with each value from the index representing the set of items that produce the specified evidence.

### Pseudocode:

TABLE 5

```
Begin Procedure BuildDependencies(V)
    Let P’ = an index of produced evidence
    -- generate an index of evidence for each item
    For each Item X in V
        for each Evidence Y in X.P
            Add X to the set P’[Y]
    -- main loop: find and map dependencies
    For each Item X in V
        for each Evidence Y in X.C
            Let A = the set P’[Y]
            for each Item Z in A
                Add Z to the set X.DependsOn
    -- complete, V now contains correct dependencies
End Procedure
```

Walking through the above method pictorially using the web site example above, the input to the method V can be represented as the following table:

TABLE 6

| Item | Set | Set Contents |
|---|---|---|
| / | .P | {URL=”/”} |
| | .C | { } |
| | .DependsOn | { } |
| /about | .P | {URL=”/about”} |
| | .C | {URL=”/”} |
| | .DependsOn | { } |
| /products | .P | {URL=”/products”} |
| | .C | {URL=”/”} |
| | .DependsOn | { } |
| /about/careers.htm | .P | {URL=”/about/careers.htm”} |
| | .C | {URL=”/about”} |
| | .DependsOn | { } |
| /about/executives.htm | .P | {URL=”/about/executives.htm”} |
| | .C | {URL=”/about”} |
| | .DependsOn | { } |
| /products/product1.htm | .P | {URL=”/products/product1.htm”} |
| | .C | {URL=”/products”} |
| | .DependsOn | { } |
| /products/product2.htm | .P | {URL=”/products/product2.htm”} |
| | .C | {URL=”/products”} |
| | .DependsOn | { } |

The .DependsOn set of each item is the empty set at the beginning of the method. It is this set that the method will construct.

When the method first executes, the variable P′ is an empty table. After the first loop executes to populate this table, P′ contains the following data, and the input V is unchanged:

TABLE 7

| Key | Value |
|---|---|
| URL=”/” | {“/”} |
| URL=”/about” | {“/about”} |
| URL=”/products” | {“/products”} |
| URL=”/about/careers.htm” | {“/about/careers.htm”} |
| URL=”/about/executives.htm” | {“/about/executives.htm”} |
| URL=”/products/product1.htm” | {“/products/product1.htm”} |
| URL=”/products/product2.htm” | {“/products/product2.htm”} |

Now, considering the first iteration of the main loop. After the line:
For each Item X in V
The variable X will contain the item “/”. The next line of code to execute is: for each Evidence Y in X.C
Since X.C is the empty set, (as shown in the above table), the inner contents of this loop will not execute, and X.DependsOn will also be the empty set.
Looking at the second iteration of the loop. In this case, X is “/about”. The line of code: for each Evidence Y in X.C
Will cause the inner loop to execute once with value Y=URL=“/”, because X.C={URL=“/”} as the above table shows. With Y=URL=“/”, the dependency system can execute the line of code:

### Let A=the set P′[Y]

And will get A={“/”} because the set of items that produce evidence URL=“/” is {“/”}.
Therefore, the line:
for each Item Z in A
Will execute once because the set A has one item, and the line:

### Add Z to the set X.DependsOn

Will result in Z=“/” and X.DependsOn equaling {“/”}.
After this second loop of execution, the input table V looks like the following (changes underlined):

TABLE 8

| Item | Set | Set Contents |
|---|---|---|
| / | .P | {URL=”/”} |
| | .C | { } |
| | .DependsOn | { } |
| /about | .P | {URL=”/about”} |
| | .C | {URL=”/”} |
| | .DependsOn | {“/”} |
| /products | .P | {URL=”/products”} |
| | .C | {URL=”/”} |
| | .DependsOn | { } |
| /about/careers.htm | .P | {URL=”/about/careers.htm”} |
| | .C | {URL=”/about”} |
| | .DependsOn | { } |
| /about/ | .P | {URL=”/about/executives.htm”} |
| executives.htm | .C | {URL=”/about”} |
| | .DependsOn | { } |
| /products/ | .P | {URL=”/products/product1.htm”} |
| product1.htm | .C | {URL=”/products”} |
| | .DependsOn | { } |
| /products/ | .P | {URL=”/products/product2.htm”} |
| product2.htm | .C | {URL=”/products”} |
| | .DependsOn | { } |

Skipping ahead to where X=“/about/careers.htm”, the example that has been presented so far. The line:

for each Evidence Y in X.C
Will execute once because X.C={URL=“/about”}, and so Y=URL=“/about”. Given this, the line:

### Let A=the set P′[Y]

Will result in A={“/about”}. Iterating through the innermost loop:
for each Item Z in A
The dependency system then sees Z=“/about” and add it to X.DependsOn with:

### Add Z to the set X.DependsOn

The input table V now looks like the following. Again, changes from the first presentation of this table have been underlined, and the skipped item “/products” has also been filled in.

TABLE 9

| Item | Set | Set Contents |
|---|---|---|
| / | .P | {URL=”/”} |
| | .C | { } |
| | .DependsOn | { } |
| /about | .P | {URL=”/about”} |
| | .C | {URL=”/”} |
| | .DependsOn | {“/”} |
| /products | .P | {URL=”/products”} |
| | .C | {URL=”/”} |
| | .DependsOn | {“/”} |
| /about/careers.htm | .P | {URL=”/about/careers.htm”} |
| | .C | {URL=”/about”} |
| | .DependsOn | {“/about”} |
| /about/ | .P | {URL=”/about/executives.htm”} |
| executives.htm | .C | {URL=”/about”} |
| | .DependsOn | { } |
| /products/ | .P | {URL=”/products/product1.htm”} |
| product1.htm | .C | {URL=”/products”} |
| | .DependsOn | { } |
| /products/ | .P | {URL=”/products/product2.htm”} |
| product2.htm | .C | {URL=”/products”} |
| | .DependsOn | { } |

When the method completes, the input table V will look like the following. All changes from the original input are underlined:

TABLE 10

| Item | Set | Set Contents |
|---|---|---|
| / | .P | {URL=”/”} |
| | .C | { } |
| | .DependsOn | { } |
| /about | .P | {URL=”/about”} |
| | .C | {URL=”/”} |
| | .DependsOn | {“/”} |
| /products | .P | {URL=”/products”} |
| | .C | {URL=”/”} |
| | .DependsOn | {“/”} |
| /about/careers.htm | .P | {URL=”/about/careers.htm”} |
| | .C | {URL=”/about”} |
| | .DependsOn | {“/about”} |
| /about/ | .P | {URL=”/about/executives.htm”} |
| executives.htm | .C | {URL=”/about”} |
| | .DependsOn | {“/about”} |
| /products/ | .P | {URL=”/products/product1.htm”} |
| product1.htm | .C | {URL=”/products”} |
| | .DependsOn | {“/products”} |
| /products/ | .P | {URL=”/products/product2.htm”} |
| product2.htm | .C | {URL=”/products”} |
| | .DependsOn | {“/products”} |

The input table V now represents a dependency graph in the .DependsOn properties of each item in the table.

As discussed above, a good performing method depends on good data structures. Although the main loop's runtime is bounded by V*X.C*P′[Y], the performance should be acceptable if the collections, specifically the collection P′, are fast. O(1) or O(Ig N) lookup time should be demanded from these collections, and therefore an appropriate data structure and/or search method should be used.

In one implementation, the above pseudocode is actually split into two separate stages. The evidence index P′ is constructed when the system asks each item for its produced evidence. P′ is represented by a B-Tree, and each node of the B-Tree contains a linked list of items that produce the specified evidence. The B-Tree data structure was selected because it permits O(Ig N) lookup of the produced evidence in the latter loop, and since the B-Tree is committed to disk, the entire tree does not need to be loaded into memory. Although O(1) lookup is possible with a disk-based data structure, a B-Tree also provides an advantage in that it makes use of hard disk block reading behavior to read larger blocks of items into memory at the same time, thereby reducing disk reads and actually increasing performance.

The method above may be modified to suit the specific implementation. For example, it is possible not only to store the items that V depends on, but for each of those items, to note those items are depended on by V. This change allows the graph to be traversed in both directions, which could be an important capability for some of the functions of an implementation of the system. The method above also implies that .DependsOn contains pointers to the items in table V, but this isn't a strict requirement; the representation of the items in the set .DependsOn can be any representation that is suitable for the implementation at hand.

By running the above method, the dependency system has solved the stated problem of creating a dependency graph based on soft references. Although the sample presented is simple, this method can be used to perform this operation with much larger and much more complex networks of items and achieve the same results. Using this system, it is not necessary for extensions or extension data to specify an explicit dependency on another extension or even its data. Besides achieving the stated goal of creating a dependency graph, this approach also permits some implementations to invoke each extension in an arbitrary order because of the soft dependencies.

In one or more various implementations, related systems include but are not limited to circuitry and/or programming for effecting the foregoing-referenced method implementations; the circuitry and/or programming can be virtually any combination of hardware, software, and/or firmware configured to effect the foregoing-referenced method implementations depending upon the design choices of the system designer.

The descriptions are summaries and thus contain, by necessity; simplifications, generalizations and omissions of detail; consequently, those skilled in the art will appreciate that the summaries are illustrative only and are not intended to be in any way limiting. Other aspects, inventive features, and advantages of the devices and/or processes described herein, as defined solely by the claims, will become apparent with respect to the non-limiting detailed description set forth herein.

Those having ordinary skill in the art will also appreciate that although only a number of server applications are shown, any number of server applications running on one or more server computer could be present (e.g., redundant and/or distributed systems could be maintained). Lastly, those having ordinary skill in the art will recognize that the environment depicted has been kept simple for sake of conceptual clarity, and hence is not intended to be limiting.

Those having ordinary skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having ordinary skill in the art will appreciate that there are various vehicles by which processes and/or systems described herein can be effected (e.g., hardware, software, and/or firmware), and that the preferred vehicle will vary with the context in which the processes are deployed.

For example, if an implementer determines that speed and accuracy are paramount, the implementer may opt for a hardware and/or firmware vehicle; alternatively, if flexibility is paramount, the implementer may opt for a solely software implementation; or, yet again alternatively, the implementer may opt for some combination of hardware, software, and/or firmware. Hence, there are several possible vehicles by which the processes described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary.

The detailed description has set forth various embodiments of the devices and/or processes via the use of depictions and other examples. Insofar as such depictions and examples contain one or more functions and/or operations, it will be understood as notorious by those within the art that each function and/or operation within such depictions and examples can be implemented, individually and/or collectively, by a wide range of hardware, software, firmware, or virtually any combination thereof.

From the foregoing it will be appreciated that, although specific implementations of the invention have been described herein for purposes of illustration, various modifications may be made without deviating from the spirit and scope of the invention.

The invention claimed is:

1. A method comprising storing dependencies between items in a graph, comprising:
storing data for each of a plurality of items including a record of dependency evidence produced by each item and a record of dependency evidence consumed by each item and a dependency record;
analyzing the data stored for each item and adding to the dependency record for each item the identity of the items that produced the consumed evidence.

2. The method of claim 1, wherein the evidence is defined to be one of a number of predefined evidence types.

3. The method of claim 2, wherein the predefined evidence types describe characteristics of the item declaring them.

4. The method of claim 3 wherein the characteristics include at least one of the following: the path name or location of the item, a uniform resource locators (URLs) describing the item, a file, directory, or network share name of the item, a software name, version, manufacturer, language, or combination of any describing the item, a service or function that is performed by the item, and an arbitrary but well-known string describing the item.

5. The method of claim 1, wherein the evidence data stored for each item is stored as unique numerical data using a well-defined one-way hash function.

6. The method of claim 5, further comprising producing the unique numerical number for each instance of evidence data.

7. A media containing instructions readable by a computer to perform a method for storing dependencies between items in a graph, the method comprising:
storing data for each of a plurality of items including a record of dependency evidence produced by each item and a record of dependency evidence consumed by each item and a dependency record;
analyzing the data stored for each item and adding to the dependency record for each item the identity of the items that produced the consumed evidence.

8. The method of claim 7, wherein the evidence is defined to be one of a number of predefined evidence types.

9. The method of claim 8, wherein the predefined evidence types describe characteristics of the item declaring them.

10. The method of claim 9 wherein the characteristics include at least one of the following: the path name or location of the item, a uniform resource locators (URLs) describing the item, a file, directory, or network share name of the item, a software name, version, manufacturer, language, or combination of any describing the item, a service or function that is performed by the item, and an arbitrary but well-known string describing the item.

11. The method of claim 7, wherein the evidence data stored for each item is stored as unique numerical data using a well-defined one-way hash function.

12. The method of claim 11, further comprising producing the unique numerical number for each instance of evidence data.
